(19) United States
(12) Patent Application Publication
(10) Pub. No.: US 2006/0257824 A1
(43) Pub. Date: Nov. 16, 2006

(54) Method of producing a dental prosthetic item, and a dental prosthetic item, a component therefor, and a blank therefor

(75) Inventors: Joachim Pfeiffer, Bensheim (DE); Wilhelm Schneider, Grasellenbach (DE)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: SIRONA DENTAL SYSTEMS GMBH

(21) Appl. No.: 11/206,179

(22) Filed: Aug. 18, 2005

(30) Foreign Application Priority Data
May 13, 2005 (DE) 10 2005 023 106.3

(51) Int. Cl. A61C 5/08

(52) U.S. Cl. 433/218; 433/223

(57) ABSTRACT

In the production of a dental prosthetic item, which dental prosthetic item comprises an at least single-membered framework, as a first component, which framework has an exterior surface to be faced by a veneer, veneering is carried out using a separately produced veneer shell, as a further component, which, optionally with the interposition of further components, has a mating surface for attachment thereof to said exterior surface of said framework and is attached to said framework. Furthermore, a dental prosthetic item produced by the aforementioned method, a component for such a dental prosthetic item, and a blank for the fabrication of such a dental prosthetic item are claimed.

### BACKGROUND OF THE INVENTION

The invention relates to a method of producing a dental prosthetic item, which comprises, as a first component, an at least single-membered framework to be faced with a veneer. A one-piece framework may be regarded as being, say, a crown cap, whilst multiple-membered frames extend over at least two dental positions.

### DESCRIPTION OF THE RELATED ART

Crowns and bridges consist of two materials having different properties, which materials are joined to one another in various ways.

In conventional dental technology, crowns and bridges are made by first producing a framework, which is subsequently veneered in order to achieve an esthetically high-quality result. The production of the frameworks takes place in some cases by means of CAD/CAM methods, but veneering is effected manually.

Thus, it is known, in particular, to cast frameworks from metals and to veneer such frameworks with a ceramic material, veneering taking place by manual layer-on-layer application of a moist ceramic powder, which is subsequently fired to achieve the desired strength. It is also known to overlay frames with a veneering compound in a manual operation.

It is further known to carry out automatic oversize application of variously colored ceramic compounds to a framework in order to achieve the desired color effect, and then to reduce the ceramic in a CAM process to a shape determined by a CAD dataset.

Instead of casting the frames, other production methods can be used, eg CAD/CAM methods. It is known, moreover, to use frames made of ceramics.

Common to all of the above methods is the presence of a core material which primarily optimally satisfies the fracture resistance requirements and an enveloping material whose primary purpose is to fulfill esthetic demands and have suitable abrasive properties with regard to the opposing tooth. Typical enveloping materials are feldspathic materials. Typical core materials are metals or oxide ceramics.

Furthermore, it is known to carve crowns from homogeneous ceramic blocks by means of CAD/CAM methods, in which the blanks used may show a color gradient, whereby the coloration of the resulting crowns is somewhat improved.

### SUMMARY AND OBJECTS OF THE INVENTION

The basic objective of the invention consists in producing a framework element, on the one hand, and a fitting veneer shell, on the other hand, and subsequently joining them to each other to give the dental prosthetic item.

The method of the invention for producing a dental prosthetic item, in which the prosthetic item comprises an at least single-membered framework, as a first component, which framework has an exterior surface to be faced with a veneer, consists in carrying out the veneering operation using a separately produced veneer shell, as a second component, which, optionally with interposition of further components, has a mating surface for attachment thereof to the exterior surface of the framework, and attaching said veneer shell to the framework.

This makes it possible to produce dental prosthetic items consisting of two types of material by means of the particularly efficient CAD/CAM methods und allows for coloration right up to the joint.

Advantageously, attachment is carried out by joining by abutment. In this case the at least two components can be joined to one another by means of a joining material or united by means of heat treatment.

Advantageously, the two components are produced in a CAD/CAM process.

In one refinement of the invention, the two components consist of different materials.

Advantageously, the material of the veneer shell is optimized esthetically and the material of the framework is optimized for strength, in each case by the choice of suitable materials. The design of the components may also be optimized with regard to these factors.

Advantageously, the joining material is dyed to achieve a desired visual effect. The geometrical profile of the joining material can be specially designed for the creation of color effects.

Advantageously, the joining layer has a gap of varying width. Using a dyed joining material can produce different coloration of the dental prosthetic item at various places thereon.

Advantageously, the material used as the joining material is glass solder, low-melting ceramics or an organic adhesive. In the case of glass solder, the components to be joined are advantageously selected such that they match one another with respect to their coefficients of expansion.

It is also possible to use as joining material one which allows for coloring thereof, eg by the action of light, after joining. It is then advantageous to perform color adjustment of the dental prosthetic item by means of the action of light during or after integration thereof in the mouth of the patient in order to achieve an optimum color match with the existing teeth.

Advantageously, the division of the prosthetic item into at least a first and second component is effected by automatic separation according to specific design algorithms. This makes it possible to design the two parts in an optimized procedure.

The veneer shell can in turn be a multiple component, ie it can be attached to the framework via an intermediate element.

The invention further relates to a dental prosthetic item which comprises an at least single-membered framework, as a first component, the framework having an exterior surface which is veneered. Furthermore, a separately produced veneer shell, as a second component, optionally with interposition of other separately produced components, is provided with a mating surface for attachment thereof to the framework, and is attached to the framework.

Advantageously, the at least two components are joined to one other by means of a joining agent.

Advantageously, the at least two components are produced by a CAD/CAM process.

Advantageously, the at least two components consist of different materials.

Advantageously, the veneer shell is optimized esthetically and the framework is optimized for strength.

Advantageously, the joining agent is dyed to achieve a desired visual effect.

Advantageously, the material used for the joining layer is glass solder, low-melting ceramics, or an organic adhesive, and the two components to be joined are selected such that they match one another with respect to their coefficients of expansion.

Advantageously, the at least two components are united by means of heat treatment.

Advantageously, between the first and second components there is disposed at least one intermediate element, as a third component, having on one side a mating surface toward the first component and on the other side a mating surface toward the second component.

The invention further relates to a component for the production of a dental prosthetic item, the dental prosthetic item comprising an at least single-membered framework, as a first component. For the purpose of veneering the framework, a separately produced veneer shell is formed, as a second component, and, optionally with interposition of other separately produced components, has a mating surface for attachment thereof to the framework.

Advantageously, the component is produced in a CAD/CAM process.

Advantageously, the component is esthetically optimized.

Advantageously, the material is suitable for joining using glass solder, low-melting ceramics, or an organic adhesive.

Advantageously, the material is suitable for joining by means of heat treatment.

The invention further relates to a blank for producing a prosthetic item composed of a number of components, which are to be carved from the blank by means of material-removing machining processes. The blank consists of a first portion of a first material for the first component and of a second portion of a second material for the second component.

This makes it possible to carry out simultaneous sequential fabrication of the two components in a single pass in the same machining equipment without interim intervention by an operator.

Advantageously, the material designated for the first component is Al₂O₃ or ZrO und the material designated for the second component is feldspar ceramics. Both materials are particularly suitable for their repective purposes, namely for the fabrication of frameworks and veneers respectively.

In a particularly advantageous embodiment, at least part of the blank designed for producing the dental prosthetic item has regions of different coloration. This, together with the dyed joining agent, makes it possible to achieve further esthetic optimization of the final dental prosthetic item.

### BRIEF DESCRIPTION OF THE DRAWINGS

Exemplary embodiments of the invention are shown in the drawings, in which:

FIG. 1 shows a dental prosthetic item having a framework and a veneer,

FIG. 2 shows a detail of FIG. 1 in the region of an interior interface,

FIG. 3 shows another dental prosthetic item, and

FIG. 4 shows a blank having different material properties for producing the components of a dental prosthetic item.

### DESCRIPTION OF EMBODIMENTS OF THE INVENTION

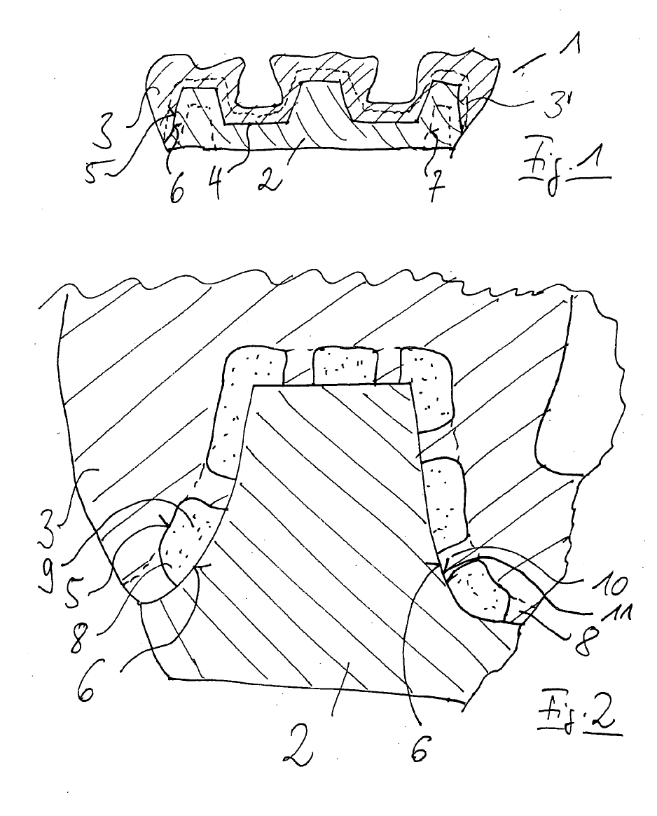

FIG. 1 shows a complete dental prosthetic item 1, to be produced in the form of a bridge, which is constructed from a first component in the form of a framework 2 and a second component of the invention in the form of a veneer 3. Between veneer 3 and framework 2, an interface 4 is present, this being formed by the interior surface 5 of veneer 3 on one side and by the exterior surface 6 of framework 2 on the other. The profile of interface 4 is preferably established automatically by means of a CAD program making allowance for the necessary design parameters.

Veneer 3 is manufactured from a material which is translucent and allows layers lying beneath veneer 3 to show through.

Framework 2 can in turn have an interior surface 7 for attachment thereof to an abutment (not shown) or to a tooth stump (not shown).

Dental prosthetic item 1 can also be more than two-part, for example when an intermediate element 3′ is inserted between veneer shell 3 and the framework. Moreover, a multiple-membered dental prosthetic item may comprise a veneer shell which is itself divided into a number of individual members or groups of adjacent members.

However, the design of the framework and veneer shell is usually such that there is only one mounting direction, so that only one veneer shell is necessary. As a rule, there is no danger when parts of the framework remain free, eg the bottom part of the bridge member.

In FIG. 2, the profile of the interface is shown in detail, there being provided, between interior surface 5 of veneer shell 3 and exterior surface 6 of framework 2, a joining layer showing a gap 8 filled with a joining agent 9.

In order to achieve a defined layer thickness of the joining layer, it is possible to provide a projection 10 in gap 8, which projection bears against exterior surface 6 with its contact surface 11.

Adhesive 9 can be dyed and have a color intensity and/or a coloration which depends on the thickness of the joining layer. If the layer thickness increases, the color intensity increases and the joining layer appears darker. With decreasing layer thickness, the color intensity decreases and the joining layer appears brighter.

Of course, joining agent 9 itself can be present in different basic colors and can be selected so as to achieve the desired color effects after introduction into the gap. The dyes in joining agent 9 show through the translucent veneer 3.

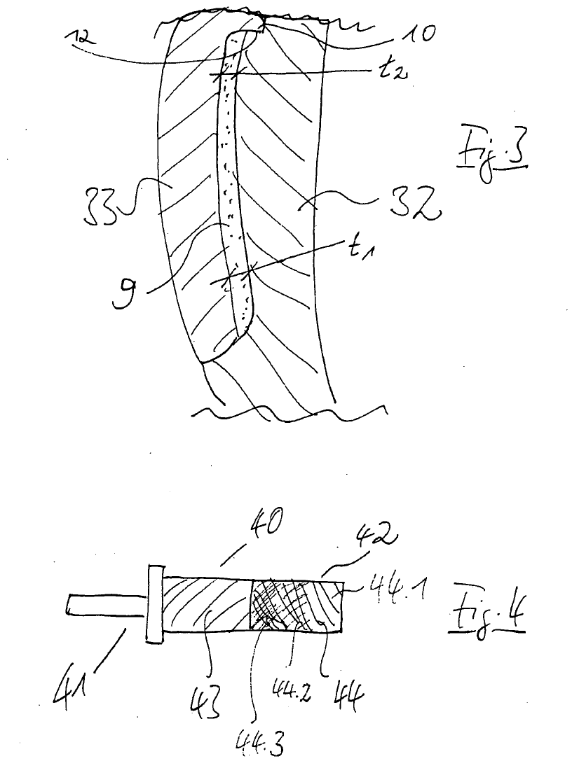

FIG. 3 shows a dental restoration in which an outside element 33 is mounted on an inside element 32. Here, a gap 8 is filled with a joining agent 9 whose layer thickness t₁ in a lower region is greater than its layer thickness t₂ in an upper region.

By means of a spacer 10 on outside element 33, which engages in a corresponding recess 12 on inside element 32, the outside element is placed in position on the inside element and the required spacing is established.

The width of gap 8 and thus the layer thickness of the joining layer can be adjusted by the design software to accommodate for the desired color gradient. On attachment of the dental prosthetic item, the adhesive is first applied in adequate measure. On pressing outside element 33 onto inside element 32, the excess adhesive is forced out through the separating gap and can be removed. When pressing the item down, care should be taken to ensure that the stop position is actually reached, so that the thickness of the joining layer will be as required and not exceeded.

In principle, joining agent 9 can be organic or inorganic. An example of a suitable inorganic joining agent is dyed glass solder.

FIG. 4 illustrates a blank for the fabrication of a dental prosthetic item consisting of a number of components, which blank 40 comprises a handle 41 for attachment to machining equipment (not shown) and a corpus 42.

Corpus 42 has two subregions 43, 44, which differ in their material composition. The differences in material composition can lie in their visual properties, for example color or translucency, but particularly in their strength values, so that one component of a multi-component prosthetic item can be produced from the one material of subregion 43 and another component can be produced from the other material of subregion 44 at a single chuck setting without changing the workpiece.

The sequence of events occurring in the method will now be explained. The method starts from CAD datasets describing the dental restoration item to be produced in the form of a core and shell.

The dataset for the framework, as the first component, can be produced by scanning an existing framework. Alternatively, the dataset can be produced by means of a CAD process by designing a framework on a preparation site existing as a dataset or on a model thereof.

The dataset for the veneer shell, as the second component, is produced in a CAD process starting from the dataset of the framework for the purpose of determining the mating surface for attachment to the framework, and from the dataset of the preparation site for the purpose of determining the exterior contour. It is possible here to produce a dataset by scanning the framework (core element) when disposed in the preparation site or to place the framework only virtually on the preparation site existing as a dataset and to produce a dataset therefrom.

Alternatively, starting from the dataset of the preparation site or a model thereof, a complete dental prosthetic item can be designed having, that is, its external contour on the one hand and the mating contour toward the preparation site on the other hand, after which the dental prosthetic item is divided into a first and second component to give the core or framework and the veneer shell respectively. This division can be carried out automatically.

Subsequently, the production of the two shapes from the materials suitable therefor takes place in a CAM process, the top side of the core being shaped as the negative of the underside of the shell and there being a gap of some 10 μm between the two parts to compensate for tolerances and for the introduction of a joining material.

After this, a permanent join is formed between the two parts. Different joining techniques are conceivable.

Mounting the shell on the surface-treated core element and heating until just below the melting point of the shell element leads to fusion thereof to the core.

Alternatively, the core element can be sprayed with a low-melting ceramics material in a thin uniform layer and the shell portion subsequently mounting thereon. Heating to above the melting point of the sprayed ceramics forms a bond between the shell element and the core element. Spraying can be carried out here using a spray containing ceramic powder.

Instead of spraying with a low-melting ceramic, a glass solder or metal solder or some other inorganic composition can be placed in the joint.

All joins of this type typically involve a temperature treatment, which results in a temperature resistant product, which means, for example, that further heat treatment processes such as glazing is possible.

Furthermore, joining can be carried out using an organic adhesive. This is then cured is either chemically or by means of light.

The color and translucency of the joining material can be specifically chosen so as to optimize the overall impression of the restoration. The shape of the joining gap can likewise be utilized for optimization of the esthetic result. It is also conceivable to use a joining material which can be colored by subsequent action of light.

The method can be assisted by the use of special blanks in which the two materials for the core and shell elements are placed on a handle such that both parts can be ground by a machine without further user interaction.

A blank of this type, however, is not a necessary prerequisite for carrying out the method, which functions equally well with a number of blanks, but at a lower degree of automation.

One rule for the division of the whole into framework and veneer can be to design the framework such that it has a uniform layer thickness which is relatively thin, eg 0.5 mm, which has the advantage that a major portion of the dental prosthetic item consists of esthetically suitable material.

Another rule for dividing the whole into framework and veneer, can be to design the veneer such that it has an approximately uniform layer thickness which is relatively thin, eg 1 mm, which has the advantage that fewer stresses occur in the less tough material of the veneer shell.

Moreover, intermediate ranges between these rules can be used, these being variable in CAD software, for example by hand.

The material provided for the first component 43 of the blank can be Al₂O₃ or ZrO and the material for the second component 44 can be a feldspar ceramic or a comparable glass ceramic, in particular a leucite-containing glass ceramic.

1. A method of producing a dental prosthetic item, wherein said dental prosthetic item comprises an at least single-membered framework, as a first component, which framework has an exterior surface which is to be faced with a veneer, wherein veneering is effected using a separately produced veneer shell, as a further component, which, optionally with interposition of further components, has a mating surface for the attachment thereof to said exterior surface of said framework and is attached to said framework.

2. A method as defined in claim 1, wherein the at least two components are joined by means of a joining material.

3. A method as defined in claim 1, wherein the two components are produced in a CAD/CAM process.

4. A method as defined in claim 1, wherein the two components are of different materials.

5. A method as defined in claim 4, wherein the material of said veneer shell is esthetically optimized and that the material of said framework is optimized for strength.

6. A method as defined in claim 2, wherein said joining material is dyed to achieve a desired optical effect.

7. A method as defined in claim 2, wherein the joining layer exhibits a gap of varying width.

8. A method as defined in claim 2, wherein said joining material used is solder glass, low-melting point ceramics or an organic adhesive.

9. A method as defined in claim 2, wherein said joining material is additionally colored after joining.

10. A method as defined in claim 1, wherein the division of said dental prosthetic item into at least a first and second component is carried out by automatic separation according to specific design algorithms.

11. A method as defined in claim 1, wherein the at least two components are joined by heat treatment.

12. A dental prosthetic item, comprising an at least single-membered framework, as first component, which framework has an exterior surface faced by a veneer, wherein a separately produced veneer shell, as second component, optionally with interposition of further, separately produced components, is provided with a mating surface for the attachment thereof to said framework and is attached to said framework.

13. A dental prosthetic item as defined in claim 12, wherein the at least two components are joined by means of a joining agent.

14. A dental prosthetic item as defined in claim 12, wherein the at least two components are produced in a CAD/CAM process.

15. A dental prosthetic item as defined in claim 12, wherein the at least two components are of different materials.

16. A dental prosthetic item as defined in claim 15, wherein the material of said veneer shell is esthetically optimized and said material of said framework is optimized for strength.

17. A dental prosthetic item as defined in claim 12, wherein said joining material is dyed to achieve a desired visual effect.

18. A dental prosthetic item as defined in claim 13, wherein said joining material is solder glass, low-melting point ceramics or an organic adhesive.

19. A dental prosthetic item as defined in claim 12, wherein the at least two components are joined by heat treatment.

20. A dental prosthetic item as defined in claim 12, wherein between the first and the second components there is disposed at least one intermediate element, as third component, having on one side a mating surface toward said first component and on the other side a mating surface toward said second component.

21. A dental prosthetic item as defined in claim 12, wherein said joining material is designed so as to achieve a desired visual effect.

22. A dental prosthetic item as defined in claim 13, wherein said joining material is disposed in a gap of varying width.

23. A component for fabrication of a dental prosthetic item, which dental prosthetic item comprises an at least single-membered framework, as first component, wherein said component is designed, for veneering said framework, as a separately produced veneer shell, as second component, and, optionally with interposition of further, separately produced components, has a mating surface for attachment thereof to said framework.

24. A component as defined in claim 23, wherein it is produced in a CAD/CAM process.

25. A component as defined in claim 24, wherein it is esthetically optimized.

26. A component as defined in claim 25, wherein the material is suitable for joining by means of solder glass, low-melting point ceramics or an organic adhesive.

27. A component as defined in claim 26, wherein the material is suitable for joining by means of heat treatment.

28. A blank for the fabrication of an at least two-component dental prosthetic item by means of a material-removal machining technique, wherein a first portion of said blank consists of a first material for a first component and a second portion of said blank consists of a second material for a second component.

29. A blank as defined in claim 28, wherein the material used for said first portion is Al₂O₃ or ZrO and the material used for said second portion is feldspar ceramics or a leucite-containing glass ceramic.

30. A blank as defined in claim 28, wherein said portion for the production of said second component has regions of different coloration.
